(19) United States
(12) Patent Application Publication
(10) Pub. No.: US 2013/0108745 A1
(43) Pub. Date: May 2, 2013

(54) COATED EFFERVESCENT TABLET

(71) Applicants: Robert Wahren, Hoellviken (SE); Bjoern Skjaevestad, Bekkestua (NO)

(72) Inventors: Robert Wahren, Hoellviken (SE); Bjoern Skjaevestad, Bekkestua (NO)

(73) Assignee: DELANTE HEALTH AS, Bekkestua (NO)

(21) Appl. No.: 13/807,466

(22) PCT Filed: Jun. 29, 2011
(86) PCT No.: PCT/SE2011/050864

§ 371 Date: Dec. 28, 2012

Related U.S. Application Data
(60) Provisional application No. 61/362,132, filed on Jul. 7, 2010.

(30) Foreign Application Priority Data
Jul. 1, 2010 (SE) 1050722-6

(51) Int. Cl. A23L 1/00; A23L 1/30

(52) U.S. Cl. CPC A23L 1/0047; A23L 1/3008
USPC 426/99; 426/96; 426/285

(57) ABSTRACT

A dietary tablet having a core containing a microencapsulated oil part and an effervescent agent, a coat which isolates the core from the environment and protects the core from oxidation and at least one ingredient giving taste. Suitable oils are preferably chosen from oils rich in polyunsaturated fatty acids, especially omega-3 and omega-6 fatty acids. The tablet is intended to be administered without water and to disintegrate in the oral cavity.

### FIELD OF INVENTION

The invention relates to a dietary tablet comprising a core comprising a microencapsulated oil part and an effervescent agent and a coat which isolates the core from the environment and protects the core from oxidation and at least one ingredient giving taste, a method to produce said dietary tablet as well as the use of said dietary tablet or process.

### BACKGROUND OF INVENTION

There is evidence from multiple studies supporting that intake of omega-3 fatty acids, like the polyunsaturated fatty acids DHA and EPA is essential for human well-being, which for instance has been reviewed by Gogus U. and Smith C. (International Journal of Food Science and Technology 2010, 45, 417-436).

Owing to their polyunsaturated nature, omega-3 fatty acids are highly susceptible to degradation by lipid oxidation, which can lead to formation of undesirable fishy and rancid off-flavours. There are even evidence of formation of toxic substances when longchained polyunsaturated fatty acid, like fish oils, are oxidized.

An attractive alternative to consumption of omega-3 containing foods, which protects the omega-3 fatty acids from oxidation, are nutritional supplements in the form of soft gelatine capsules, but some people have problems to swallow tablets and capsules.

Inability or unwillingness to swallow solid dosage forms such as tablets and capsules is a constant problem for some people. A problem most frequently encountered by children and the elderly. To overcome these problems, the pharmaceutical industry has developed different types oral dosage forms, such as solutions, specially designed tablets (e.g. lozenge, orodispersible, chewable). For this group, acceptable solid oral dosage forms have to disintegrate in the mouth, as well as having sensory acceptable properties.

There are two types of tablets intended to dissolve in the oral cavity; lozenges and orodispersible tablets. Lozenges are solid preparations intended to dissolve or disintegrate slowly in the mouth. The name troche is applied to compressed lozenges. Orally disintegrating tablets/orodispersible tablets are solid unit dosage forms, which disintegrate or dissolve rapidly in the mouth without chewing and water. European Pharmacopoeia (EP), defines orodispersible tablets as “uncoated tablets intended to be placed in the mouth where they disperse rapidly before being swallowed”. Effervescent compositions have been employed to obtain uncoated rapid dissolution and/or dispersion of the medicament in the oral cavity.

There also exists effervescent dietary supplements of encapsulated omega-3 oils (Wahren R. and Skjaevestad B. (WO/2006/088418)) which should be dispersed in water prior to consumption, available for groups of consumers which encounter difficulties in swallowing capsules, but these dosage forms need access to water or other fluid in a glass which is not always available. Wahren R. and Skjaevestad B. disclose in their patent application (WO/2006/088418) a tablet composition comprising a powder containing microencapsulated polyunsaturated long-chain esterified fatty acids distributed in an effervescent formulation. However, compression of the powder needed for tablet formation according to this invention, makes the poly unsaturated fatty acids susceptible to oxidation, resulting in a fishy smell just hours after powder compression.

There are some related disclosures available among which WO 2006/088418 is one. The application discloses a formulation of polyunsaturated longchained esterified fatty acids (e.g. fishoil) evenly distributed in an effervescent base indented to be dispersed in an aqueous media. The invention also relates to a process for production of tablets comprising said composition. However, the problem with such simple tablets pressed containing microdispersed fish oil powders is that they are very susceptible to oxidation, resulting in the development of bad smell, odour or taste. Thereby the tablet cannot be stored and the intended amount of the polyunsaturated longchained esterified fatty acids will be reduced during the storage of the tablets.

EP 1920663 discloses a protective coating for an oxidative sensitive core material by addition of a system consisting of two components, an antioxidant and a lipid based polymer system. In the description of the invention, the use of the term core material, ingredient (e.g. a free flowing powder containing omega-3 oil), active and substance is used interchangeably and denotes a component having a desirable perceived property, such as food, pharmaceutical, physiological or fragrance. The disclosed invention relates to a coating composition that protects the core material from oxygen and water. This means that a formulation that is a lipid coated one, will not disintegrate in the mouth so people that have problems to swallow large dose forms cannot use these formulations, without unpleasant feelings. Lipid excipients are also known to barrier properties that sustain and/or delay release of a core material in the gastrointestinal tact.

WO 2009/056247 provides an oral composition containing PUFA (polyunsaturated fatty acids), wherein said PUFA are mixed with active charcoal. The function of the activated charcoal, according to the invention, is to absorb the bad or fishy smell, odour or taste, i.e., they allow the PUFA to be degraded and solely mask the bad smell instead of providing a product that also provide intact PUFA to the mammal.

There are still problems to be solved to be able to provide a new optimal product containing polyunsaturated longchained esterified fatty acids which do not become oxidised and which are provide to the consumer in an optimal way so that the consumer will receive polyunsaturated longchained esterified fatty acids that are intact. The product should be adapted for the consumer and should not during storage produce any bad smell or taste which is a sign that the fatty acids no longer are intact and no longer can act as they are intended to. Additionally it is optimal if the consumer could be exposed to the PUFA already in the mouth so that the PUFAs can act in the optimal way in the mammalian body.

### SUMMARY OF THE INVENTION

The present invention relates to dietary tablets comprising a protective coating, wherein said tablets are formed by compressing a powder containing oxidative sensitive esters of oil, such as omega 3 fatty acids in combination with a hygroscopic effervescent agent. The tablet is intended to be administered without water and to disintegrate in the oral cavity.

The invention relates to a new product being tablets, such as chewable tablets that contain polyunsaturated longchained esterified fatty acids in a high intact amount and an effervescent base. These tablets are after they are pressed coated with a film forming material that have good oxygen barrier properties. (see example below) and good mechanical properties. This makes it possible to store these tablets in multiple-unit containers which can be opened many times, resulting in both reduced cost and reduced environmental impacts of the packaging system. By such a product it is possible for the first time to include a high amount of PUFA in a product as well as providing PUFA in the intact form that are rapidly dispersed in the saliva of the consumer. Thereby the consumer is exposed to a new and improved product containing PUFAs, which has solved a number of problems, the PUFAs are intact, there is no smell or bad taste, it is possible to store the product. The product is also degraded in the upper part of the gastrointestinal tract and thereby available to the consumer in an optimal way.

In a first aspect the invention relates to a dietary tablet comprising a core comprising a powder comprising oil and an effervescent agent and a coat which isolate the core from the environment and protect the core from oxidation and at least one ingredient giving taste.

The coating solves a main problem. When a tablet containing an oil powder is compressed, some oil will become exposed to air and start deteriorating, causing a rancid, fishy smell. The coating protects the tablet, keeping the smell and taste of the tablet intact and fresh, see Example 1. Also, the coating prevents oxygen to come in contact with non-encapsulated oil left on the outside of the particles, often a problem in conventional spray drying, thereby preventing oxidation of the unsaturated lipids on the surface of the oil powder, and increasing the shelf life.

The effervescent formulation tends to stimulate saliva production, thereby providing additional aqueous media to aid in further effervescent action and subsequential disintegration of the tablet. The dosage form gives an agreeable presentation of the oil containing powder, particularly for patients who have difficulty in swallowing capsules. The coating will also increase the strength of the tablets, making them more resistant to damage in the course of distribution.

In a second aspect the invention relates to a process for the preparation of a dietary tablet comprising the steps of; providing powder of oil and an effervescent agent, mixing and compressing said powders and obtaining a core, coating said core and obtaining a dietary tablet.

In a final aspect the invention relates to the use of the above defined dietary tablet as well as the process.

### DETAILED DESCRIPTION OF EMBODIMENTS OF THE INVENTION

### PUFA Composition

The invention relates to a new dietary tablet which are coated and supposed to be used by humans. The core of the tablet being substantially free from water and comprising a powder of oil, such as microencapsulated/encapsulated long chain esterified fatty acids (PUFA), wherein said content of said PUFA's is from 5 to 70% (w/w), said powder being homogenously distributed in an effervescent agent. The PUFA in the composition may be in an amount of 5 to 40% (w/w), such as 5-40%, 5-30%, 15-20%, 10-40%, 15-40%, 20-40%, 15-35% or 20-30% (all values being w/w), or in an amount of 5, 10, 15, 20, 25, 30, 35, 40, 45 or 50%. Additionally the effervescent agent may be in an amount of 5-75%, 5-10, 20-75%, 20-60%, 40-64%, 15-45%, 15-50%, 10-45%, or 35-55% (all values being w/w) or in an amount of 5-35%, such as 5, 10, 15, 20, 25, 30, 35%, 40% or 45%. The PUFA may be any PUFA, such as omega-3 and/or omega-6, such as oils having a high content of PUFA.

The core may comprise different kinds of PUFA as well as the PUFA's may be microencapsulated/encapsulated in different ways providing a mixture of different microencapsulated/encapsulated PUFA's as well as mixtures of different fat soluble antioxidants.

The dietary tablet comprises a microencapsulated oil part of which can be a long chain polyunsaturated fatty acid, which may be obtained from vegetable, microorganism or animal sources, such as fish, mussel, algae, oyster, krill and shrimp and where an microencapsulation agent acceptable for human consumption, may be polymeric carbohydrate or modified polysaccharide like starch or a modified starch.

### The Microencapsulated Oil Part

Encapsulating of food oils is a well known technique for a person skilled in the art, which offers great value to manufacturers because they result in enhanced stability, while delivering a desired fatty acid profile in a form that is easy to handle.

Different techniques used to stabilize omega-3 PUFA's have recently been reviewed by both Rubio-Rodriguez N. et al (Innovative Food Science and Emerging Technologies 11 (2010) 1-12) and Thueringer S. (Functional ingredients, April 2009 page 28-30). Of the reviewed methods for encapsulation or microencapsulation, spraydrying is the most common and cheapest one.

The microencapsulating technique may make use of polysaccharides such as cellulose and starch, modified or unmodified, or protein containing materials. Microencapsulated techniques such as spray-drying of emulsions has been described by Kolanowski et. Al., Int J Food Sci Nutr. 2004 June; 55(4):333-43 and Hogan in J Microencapsul. 2003 September-October; 20(5):675-88. However, unencapsulated fat left on the surface of the particles after drying are in many cases a major problem that limit the shelf life of the product, a problem this invention solves.

Nu-Mega (Brisbane, Queensland, Australia) produces a tuna oil in a stable dry powder form and National Starch Food Innovation has introduced in the United States an encapsulated long-chain omega-3 fatty acid in powder form under the name NOVOMEGA™ which contains an fish oil from Omega Protein Corporation (Houston Tex. USA).

Microencapsulation may be at the molecular level, such as with inclusion within a cyclodextrin molecule, spray drying, coacervation and carrageenan entrapment. Examples of microencapsulation techniques include; emulsions of menhaden oil and sodium caseinate (NaCas) incorporating carbohydrates of varying dextrose equivalence (DE) spray-dried to yield encapsulated fish oil powders.

MEG-3TM Omega-3 Powder and Meg-3TM Omega-3 DHA Powder use a novel form of micro-encapsulation, which creates an unsurpassed “no taste, no smell” form of powdered fish oil ingredient for inclusion in food products. (Ocean Nutrition Canada Ltd).

Vana-sana DHA 18 ES is a high stability fish oil powder, jointly developed by Kievit and Lipid Nutrition. Use of a special sugar alcohol, known to have radical scavenging activity increased stabilising properties of the powder matrix. Other examples are encapsulation of wheat germ oil and evening primrose oil using the chemical reaction between the water-soluble sodium alginate and the polyvalent cation, calcium, to form the water-insoluble alginate sodium alginate has been reported.

Gamma-cyclodextrin inclusion complex of cranberry seed oil called OmegaDry® Cranberry is available from Wacker Specialties. OmegaDry Cranberry combines the nutritional properties of cranberry seed oil with the functional benefits of microencapsulation on the molecular level. It contains 45% cranberry seed oil.

The fatty acids according to the invention may be selected from the group of polyunsaturated fatty acids, such as linoleic acids, linolenic acids, eicosanoids fatty acids, omega-3 fatty acids and omega-6 fatty acids.

Examples of different polyunsaturated fatty acids (PUFA) and classes of PUFA are listed below:
Linoleic Acids including conjugated ones and synthetic versions
Linolenic Acids, such as Alpha-Linolenic Acid (ALA) and Gamma-Linolenic Acid (GLA)
Eicosanoids, such as Eicosapentaenoic Acid (EPA) and Arachidonic Acid (ARA)
Fatty Acids, Omega-3, such as Eicosapentaenoic Acid (EPA), Docosahexaenoic Acids (DHA) and Alpha-Linolenic Acid (ALA)
Fatty Acids, Omega-6, such as Linoleic Acids and gamma-Linolenic Acid (GLA)

The oil part in the dietary tablet may be selected from the group consisting of seal oil, squid oil, flaxseed oil, evening primrose oil, algae oil, borage oil, hemp seed oil, perilla oil, blackcurrant seed oil, vitamin E, rice bran oil, cranberry oil, cod liver oil, tuna oil, anchovy oil, horse mackerel oil, sardine oil, menhaden oil, krill oil, salmon oil, pilchards oil, corn oil, grape-seed oil, wheat germ oil, shark liver oil and olive oil. These oils being excellent sources for certain components, but transgenic plants have also been proposed as an alternative source of omega-3 fatty acids. Flaxseed oil which is a source of alpha-linolenic acid (ALA), evening primrose oil which is a source of gamma-linolenic acid (GLA). Algae oil being rich in DHA. (e.g. microalgae-derived DHA oil, Martek Biosciences), borage oil being a source of gamma-linolenic acid (GLA), hemp seed oil being a source of alpha-linolenic acid (ALA) and GLA, perilla oil being a source of alpha-linolenic acid (ALA) and blackcurrant seed oil being a source gamma-linolenic acid (GLA), alpha-linolenic acid (ALA) and linoleic acid.

Further examples of other oils with health benefits are as follows; vegetable oils such as canola, sunflower, safflower, palm oil and wheat germ oils being rich in vitamin E, rice bran oil which contains three different kinds of natural antioxidants—namely tocopherol, tocotrienol, and oryzanol, cranberry oil which contains tocopherols, tocotrienols, and phytosterols, cod liver oil being a one source of both vitamins A and D, flaxseed oil which contains varying amounts of lignan, corn oil which contains a natural mixture of both free and esterified phytosterols, grape-seed oil being rich in vitamin E and proanthrocyanidins, wheat germ oil containing octacosanol and shark liver oil and olive oil which contain squalene, a 30-carbon isoprenoid. The different oils and oil sources mentioned above can be processed in different ways to increase the content of for example PUFA, or optimise the content of lipophilic bioactive compounds. “Structured lipids” (SL) are glycerides of fatty acids that have been modified to change the fatty acid composition and/or their positional distribution in the glycerol backbone by chemically and/or enzymatically catalyzed reactions and/or genetic engineering. More specifically, SLs are modified lipids with improved nutritional or functional properties. Eicosapentaenoic acid, 20:5n-3 (EPA), and docosahexaenoic acid, 22:6n-3 (DHA), found in fish oil, are examples of n-3 polyunsaturated fatty acids (PUFAs) of interest in SL production.

Examples of processes are transformations of lipids e.g. hydrolysis, esterification, and reesterification can increase the content of PUFA. Biochemical transformations have been review by Neklyudov et al 2002 “Biochemical Processing of Fats and Oils As a Means of Obtaining Lipid Products with Improved Biological and Physicochemical Properties: Applied Biochemistry and Microbiology 38: 399-409), in which expose of cold pressed oils to very mild process conditions such as, mechanical procedures without the application of heat. Cold pressed, nonrefined evening primrose oil (EPO) was recently found to contain lipophilic triterpenoidal esters with radical scavenging and anti-inflammatory properties. Cold pressed seed (e.g raspberry, black raspberry and boysenberry) oils have relatively high antioxidant activity. Supercritical Fluid Technology is powerful tool for the food and nutritional industry as for instance disclosed by Dunford et al. in U.S. Pat. No. 6,677,469 discloses the use of a supercritical fluid fractionation process for phytosterol ester enrichment in vegetable oils. Molecular distillation is a refinement process for the concentration and purification of PUFA like EPA and DHA. As in any distillation process, it is based on molecular weight fractionation. Low molecular esters, such as ethanol and methanol esters are more easily distilled than the glyceride esters of fatty acids. However, other techniques may also be used as well as mixture of the above mentioned techniques.

The oil use in the dietary tablet many be contained in an encapsulated material based on carbohydrate materials, starch or enzymatic or chemically modified starch.

### The Effervescent Agent

Effervescence is the reaction (in water) of acids and bases producing carbon dioxide. Examples of acids used in this reaction are citric acid, tartaric acid, malic acid, fumaric acid, adipic acid, acid citrates, succinic acid and mixtures thereof. Citric acid is the most commonly used, and it imparts a citrus-like taste to the product. Examples of bases used in the effervescent reaction are sodium carbonate, potassium carbonate, sodium bicarbonate, potassium bicarbonate, calcium bicarbonate, magnesium carbonate, sodium glycocarbonate, carboxylysine and mixtures thereof. Sodium bicarbonate is very common in effervescent formulas.

### The Dietary Tablet

The above mentioned dietary tablet may comprise at least one additive selected from the group comprising binders, lubricants, emulsifiers fillers, surfactants (e.g., polysorbate 80 and sodium lauryl sulfate), flavours, aromas (examples of ingredients giving taste) (such as orange, lemon, bergamon, grapefruit, banana, apricot and strawberry) and colours, including natural or synthetic ones, vitamins, sweeteners (examples of ingredients giving taste) (acesulfame potassium, sodium saccharin, aspartame, stevia and surcalose), nutritional additives (e.g antioxidants, peptides), and mixtures thereof.

Substances giving taste, colour or antioxidative properties to the effervescent dietary composition can be plant polyphenols (Cheynier V. Am J Clin Nutr. 2005; 81: 223-229) coming from natural sources such as blueberries, cranberries, grapes and tea leaves.

Additionally the tablet may contain various lubricants suitable for use in the composition including water dispersible, water soluble, water insoluble lubricants and combinations thereof. Examples of useful water soluble lubricants include sodium benzoate, polyethylene glycol, L-leucine, adipic acid, and combinations thereof.

The tablet may also include water insoluble lubricants including, e.g., stearates (e.g., magnesium stearate, calcium stearate and zinc stearate), oils (e.g., mineral oil, hydrogenated and partially hydrogenated vegetable oils, and cotton seed oil) and combinations thereof. The effervescent agent may also comprise vitamins, and minerals as disclosed in U.S. Pat. No. 4,725,427 “Effervescent vitamin-mineral granule preparation”.

The invention also relates to a process for the preparation of the coated dietary tablet, comprising the steps of; providing a microencapsulated/encapsulated oil part and an effervescent agent, mixing and compressing said microencapsulated oil part and said effervescent agent and obtaining a core, and coating said tablets. A step of spray-drying may be included in the process.

The manufacturing process involves some critical steps that need to be addressed carefully during formulation and manufacturing which is well known for a person skilled in the art. Production of effervescent products must occur in very low humidity areas. The best way to produce an effervescent product is in an environment where humidity is under strict control.

The process of producing tablets, known as “tableting” or “compressing” requires addition of pharmaceutical excipients well known to a person skilled in the art of powders like mixing, granulation and tableting. It is common practice in tablet production to add a lubricant after granulation; the most commonly used substance is magnesium stearate. During effervescent production, substances such as magnesium stearate can generate a problem since they are insoluble in water and, consequently, a film will form on top of the water after the tablet has dissolved. Strategies to overcome this problem are the use of other lubricants that are soluble in water; for example, a mixture of spray dried L-leucine and polyethylene glycol. Alternatively, not using any lubricant has the advantage of avoiding the blending step, but the disadvantage of special requirements for the tablet press.

### Coating

Coatings applied in thin films to tablets are done for various reasons; they can for instance modify release of biologically active substances, clarify identification of products, and make tablets easier to swallow. Coating materials are also used for protection of biological active substances from the environment e.g. air, moisture and light. Coating materials which function as moisture barriers and/or protects from oxidation can be found among both pharmaceutically acceptable materials and components used for the preparation of edible films for the food industry. Edible film forming materials have been classified by Bourtoom (International Food Research Journal 15(3): 237-248 (2008)) into three categories: hydrocolloids (such as proteins, polysaccharides, and alginate), lipids (such as fatty acids, acylglycerol, waxes) and composites (mixtures of the other two classes).

One reason to coat tablets is to provide a barrier against moisture and oxygen. Shellac and zein films are examples of coatings that are used in food applications. Zein is the water-insoluble prolamine from corn gluten. It is unique in its ability to form odorless, tasteless, clear, hard and almost invisible edible films. Since Zein films are completely safe to ingest, it is the perfect coating for foods and pharmaceutical ingredients. Zein films provide an excellent gas barrier against oxygen at low water contents

Modified cellulose, such as methyl mellulose (MC), hydroxyl propyl methyl cellulose (HPMC), hydroxypropyl cellulose (HPC) and carboxymethyl cellulose CMC possess good film-forming characteristic; films are generally odorless and tasteless, flexible and moderate protection to moisture and oxygen transmission.

Film forming chitosans are clear, tough, flexible and have good oxygen barrier properties. Films produced from high amylose corn starch has also been reported to be good oxygen barrier properties

Synthetic polymers may also be used. Polyvinyl alcohol is odorless tasteless and used as a barrier film for food supplement tablets. BASF, has under the trade name Kollicoat, developed a polyvinyl alcohol-polyethylene glycol graft copolymer for instant release coating for tablets which exhibits reliable protection properties for active ingredients against light, oxygen and moisture.

### EXAMPLES

### Example 1

The biggest problem with deterioration in the quality of fish oil is rancidity, a rancid taste indicates a poor oil quality. To test rancidity after tablet formation and after compression, the following experiments were performed.

Powders (2 gram) containing omega-3 microencapsulated oil where compressed to tablets and stored in 100 ml plastic containers with a closed lid. The same amount of free flowing powders with microencapsulated omega-3 was stored in identical containers.

The containers were opened and checked for rancid, fishy smell related to oxidized omega-3 oils. The results are summarized in the table below.

| | Hours before any rancid smell | |
|---|---|---|
| | could be detected. | |
| Omega 3 powder | Free flowing | Compressed |
| supplier | powder. | tablets |
| Ocean Nutrition, | More than 48 h | 4 hours |
| Canada | | |
| Denomega Nutritional | More than 48 h | 4 hours |
| Oils, Norway | | |
| DSM Nutrition, | More than 48 h | 24 hours |
| Switzerland | | |

The experiments clearly show that it is possible to make tablets by compression of just the encapsulated powder, but production of tablets by compression makes the fish oil susceptible to oxidation, resulting in an easily detected rancid smell.

### Example 2

Tablets were made from Omega-3 powder (DSM Nutrition, Switzerland) citric acid, sodium bicarbonate, sucralose, orange, banana and apricot flavours and beta carotene and compressed to tablets which were coated with Kollicoat® IR (polyvinyl alcohol-polyethylene glycol graft copolymer from BASF Aktiengesellschaft, Germany) dissolved in an ethanol/water solution.

The dried coated tablets were stored in 100 ml plastic containers with a closed lid. The containers were opened weekly and checked for rancid smell. No rancid smell was detected even after 4 months. The example shows that coating of the tablets can protect the fish oil from oxidation, even though the protective encapsulation is ruptured by compression during the tablet formation as shown in Example 2.

When placed in the oral cavity the tablets disintegrated in less than 1 minute, with a pleasant taste.

### Example 3

An acceptable tablet should have good dispersion properties and give a good sensory profile after it has been placed in the oral cavity. Sensory evaluation was made of tablets with various contents of effervescent formulation one minute after they were placed in the oral cavity. The PUFA composition, an omega-3 powder was obtained from DSM Nutrition, Switzerland. The effervescent formulation was a mixture of citric acid, sodium bicarbonate, orange and banana aromas and beta carotene.

Results of the tests are summarized in the following table.

| | Sensory evaluation, after 1 minute in |
|---|---|
| Composition of tablets | oral cavity |
| 100% omega-3 powder | Formation of lumps, sticking to the teeth |
| 95% omega-3 formulation, | Partially disintegrated |
| 5% effervescent formulation | |
| 90% omega-3 powder, | Partially disintegrated |
| 10% effervescent formulation | |
| 85% omega-3 powder, | Partially disintegrated |
| 15% effervescent formulation | Fizzy sensation |
| 65% omega-3 powder, | Fully disintegrated with fizzy sensation |
| 35% effervescent formulation | |

The sensory evaluation shows that tablets with only compressed omega-3 powder had unacceptable dispersion properties, and tablets with 85% omega-3 powder and 15% effervescent formulation or more gave a fizzy sensation in the mouth during disintegration.

### Example 4

The formulation presented in the table below was pressed into tablets with a weight of 1.15 grams, using an excenter press. Resistance to crushing of the tablets was then measured according to the European Pharmacopeia, 01/2008/20908 and found to vary between 4 to 7 kp.

| Ingredient | Supplier | % w/w |
|---|---|---|
| Omega-3 powder | DSM | 57.6 |
| Citric Acid | Brenntag | 18.4 |
| Sodium bicarbonate | Brenntag | 20.5 |
| Sweeteners | Barentz | 0.3 |
| Orange flavour | IFF | 2.6 |
| Banana flavour | Givaudan | 0.5 |
| Betakaroten | BASF | 0.2 |

These tablets where subsequently coated with Shellack and stored in a plastic bottle. Every two weeks tablets were removed and tasted. This procedure went on for three months, without detection of any bad taste or odor.

1. A dietary tablet comprising:
a core comprising a powder comprising an oil and an effervescent agent and
a coat which isolate the core from the environment and protect the core from oxidation,
and
at least one ingredient giving taste.

2. The dietary tablet according to claim 1 wherein the long chain esterified fatty acids of said oil is/are omega-3 and/or omega-6.

3. The dietary tablet according to claim 1, wherein said oil is fish oil or aconcentrate of fish oil.

4. The dietary tablet according to claim 1, wherein said oil is in an amount of from 5 to 70% (w/w) and said effervescent agent is from 5 to 75% (w/w) of said core.

5. The dietary tablet according to claim 4, wherein said oil is in an amount of from 10 to 40% (w/w) and said effervescent agent is from 15 to 45% (w/w).

6. The dietary tablet according to claim 1, wherein said coat is selected from the group consisting of hydrocolloids, lipids and composites, Shellac, Zein, cellulose, modified cellulose, chitosan, synthetic polymers and starch.

7. The dietary tablet according to claim 1, wherein said coat is selected from the group consisting of proteins, polysaccharides, alginate, fatty acids, acylglycerol, waxes or mixtures thereof.

8. The dietary tablet according to claim 7 wherein said coat is polyvinyl alcohol-polyethylene glycol copolymer.

9. A process for the preparation of a dietary tablet comprising the steps of;
a) providing powder of oil, at least one ingredient giving taste and an effervescent agent,
b) mixing and compressing said powders and obtaining a core,
c) coating said core and
d) obtaining a dietary tablet.

10. (canceled)
